(19) United States
(12) Patent Application Publication
(10) Pub. No.: US 2024/0295884 A1
(43) Pub. Date: Sep. 5, 2024

(54) Orientation, Acclimation, Navigation, and Location System for a Lawn Mower Blade Sharpening and Task Apparatus

(71) Applicant: Brian F. Smith, Monkton, MD (US)

(72) Inventor: Brian F. Smith, Monkton, MD (US)

(21) Appl. No.: 18/588,759

(22) Filed: Feb. 27, 2024

Related U.S. Application Data
(60) Provisional application No. 63/449,186, filed on Mar. 1, 2023.

(51) Int. Cl. G05D 1/656; A01D 75/08; G05D 1/242; G05D 1/243; A01D 101/00; G05D 105/15; G05D 107/20; G05D 111/10

(52) U.S. Cl. CPC G05D 1/656; A01D 75/08; G05D 1/242; G05D 1/243; A01D 2101/00; G05D 2105/15; G05D 2107/23; G05D 2111/10

(57) ABSTRACT

Provided are systems and methods for orientating a robot relative to a lawn mower. The system may include at least one processor configured to determine first object data associated with a first component of the lawn mower based on a first signal received from a sensor, where the first signal is detected at a first location. The processor may be configured to control a drive system to drive from the first location to a second location based on the first object data. The processor may be configured to determine second object data associated with a second component of the lawn mower based on a second signal received from the sensor, where the second signal is detected at the second location. The processor may be configured to control the robot to perform a task based on the second object data.

### CROSS REFERENCE TO RELATED APPLICATION

The present application claims the benefit of United States Provisional Patent Application No. 63/449,186 filed on Mar. 1, 2023, the disclosure of which is hereby incorporated by reference in its entirety.

### BACKGROUND

### 1. Technical Field

The present disclosure relates to orientating, acclimating, navigating, and locating an environment, and in some non-limiting embodiments, a system for orientating, acclimating, navigating, and locating an environment of a lawn mower blade sharpening and task apparatus underneath a lawn mower.

### 2. Technical Considerations

Lawn mowers include blades that are used to cut grass. The blades of a lawn mower must be kept sharp to run efficiently and to prevent disease of grass. Typical methods for sharpening blades of a lawn mower require a user to detach the blades from underneath a bottom side of the lawn mower, sharpen the blades, and re-attach the blades. Such methods may be performed manually or via a robot.

Accuracy for understanding and/or addressing issues associated with the blades of a lawn mower and/or other components of a lawn mower (e.g., wheels, discharge chutes, mower decks, etc.) is paramount to the care of a lawn mower. In order to service and/or view the blades of a lawn mower and/or other components of a lawn mower, an individual must jack-up the lawn mower and/or lawn mower deck, and/or remove the lawn mower deck, and/or manually guide a viewing device under the lawn mower and/or lawn mower deck. This proves to be antiquated, time consuming, and/or difficult for most individuals.

Therefore, a need exists in the field for an autonomous robot that navigates, acclimates to, and/or locates objects under a lawn mower and/or lawn mower deck in order to orient, navigate and/or acclimate to the environment in order to locate the lawn mower blades, wheels, discharge chute, sides of a mower deck, and/or the underside of a mower deck in order to autonomously drive to desired and/or required location(s) relative to the lawn mower blades.

### SUMMARY

In some non-limiting embodiments, provided is a system for a robot configured to orient the robot relative to a lawn mower comprising a plurality of components. In some non-limiting embodiments, the system may include a drive system configured to move the robot, at least one sensor, and/or at least one processor. In some non-limiting embodiments, the at least one processor may be operatively connected to the drive system and the at least one sensor. In some non-limiting embodiments, the at least one processor may be configured to determine first object data associated with at least one first component of the plurality of components of the lawn mower based on a first signal received from the at least one sensor. In some non-limiting embodiments, the first signal may be detected by the at least one sensor at a first location. In some non-limiting embodiments, the first location may be a location adjacent to a first side of the lawn mower. In some non-limiting embodiments, the at least one processor may be configured to control the drive system to drive from the first location to a second location based on the first object data. In some non-limiting embodiments, the second location may be a location underneath a second side of the lawn mower. In some non-limiting embodiments, the at least one processor may be configured to determine second object data associated with at least one second component of the plurality of components of the lawn mower based on a second signal received from the at least one sensor. In some non-limiting embodiments, the second signal may be detected by the at least one sensor at the second location underneath the second side of the lawn mower. In some non-limiting embodiments, the at least one processor may be configured to control the robot to perform a task based on the second object data associated with the at least one second component of the plurality of components of the lawn mower.

In some non-limiting embodiments, the at least one sensor may include at least one second processor. In some non-limiting embodiments, the at least one second processor may be configured to detect at least one signal and/or communicate the at least one signal to the at least one processor.

In some non-limiting embodiments, the at least one sensor may include one of a light detection and ranging (LiDAR) sensor, a time-of-flight (ToF) sensor, a proximity sensor, an optical sensor, an image sensor, and/or any combination thereof.

In some non-limiting embodiments, the drive system may include at least one second processor. In some non-limiting embodiments, the at least one second processor may be configured to receive data from the at least one processor, the data comprising instructions to drive from the first location to the second location, and/or drive the robot from the first location to the second location in response to receiving the instructions.

In some non-limiting embodiments, the drive system may include at least one of a motor, a wheel, a ball, a track, and/or any combination thereof.

In some non-limiting embodiments, the system may further include at least one camera. In some non-limiting embodiments, the at least one processor may be further configured to control the at least one camera to capture the first object data associated with at least one first component of the plurality of components of the lawn mower. In some non-limiting embodiments, the first object data may be captured at the first location adjacent to the first side of the lawn mower.

In some non-limiting embodiments, the at least one processor may be further configured to determine the second location underneath the second side of the lawn mower based on the first object data.

In some non-limiting embodiments, the system may further include a database. In some non-limiting embodiments, the database may include a plurality of existing object data records. In some non-limiting embodiments, the at least one processor may be further configured to query the database to determine whether or not the first object data associated with the at least one first component of the plurality of components of the lawn mower matches at least one existing object data record of the plurality of existing object data records.

In some non-limiting embodiments, based on determining that the first object data associated with the at least one first component of the plurality of components of the lawn mower matches the at least one existing object data record of the plurality of existing object data records, the at least one processor may be configured to determine the second location underneath the second side of the lawn mower.

In some non-limiting embodiments, based on determining that the first object data associated with the at least one first component of the plurality of components of the lawn mower does not match the at least one existing object data record of the plurality of existing object data records, the at least one processor may be configured to generate an object data record comprising the first object data associated with the at least one first component of the plurality of components of the lawn mower, update the plurality of existing object data records to include the object data record comprising the first object data associated with the at least one first component of the plurality of components of the lawn mower to provide an updated plurality of existing object data records, and/or determine the second location underneath the second side of the lawn mower based on the updated plurality of existing object data records.

In some non-limiting embodiments, the at least one second component of the plurality of components of the lawn mower may include a blade, where the task may include sharpening the blade.

In some non-limiting embodiments, provided is a method for orienting a robot relative to a lawn mower. In some non-limiting embodiments, the robot may include a drive system configured to move the robot and/or at least one sensor. In some non-limiting embodiments, the at least one processor may be operatively connected to the drive system and/or the at least one sensor. In some non-limiting embodiments, the lawn mower may include a plurality of components. In some non-limiting embodiments, the method may include determining first object data associated with at least one first component of the plurality of components of the lawn mower based on a first signal received from the at least one sensor. In some non-limiting embodiments, the first signal may be detected by the at least one sensor at a first location. In some non-limiting embodiments, the first location may be a location adjacent to a first side of the lawn mower. In some non-limiting embodiments, the method may include controlling the drive system to drive from the first location to a second location based on the first object data. In some non-limiting embodiments, the second location may be a location underneath a second side of the lawn mower. In some non-limiting embodiments, the method may include determining second object data associated with at least one second component of the plurality of components of the lawn mower based on a second signal received from the at least one sensor. In some non-limiting embodiments, the second signal may be detected by the at least one sensor at the second location underneath the second side of the lawn mower. In some non-limiting embodiments, the method may include controlling the robot to perform a task based on the second object data associated with the at least one second component of the plurality of components of the lawn mower.

In some non-limiting embodiments, the at least one sensor may include one of a light detection and ranging (LiDAR) sensor, a time-of-flight (ToF) sensor, a proximity sensor, an optical sensor, an image sensor, and/or any combination thereof.

In some non-limiting embodiments, the drive system may include at least one of a motor, a wheel, a ball, a track, and/or any combination thereof.

In some non-limiting embodiments, the robot may further include at least one camera. In some non-limiting embodiments, the method may further include controlling the at least one camera to capture the first object data associated with at least one first component of the plurality of components of the lawn. In some non-limiting embodiments, the first object data may be captured at the first location adjacent to the first side of the lawn mower.

In some non-limiting embodiments, the method may further include determining the second location underneath the second side of the lawn mower based on the first object data.

In some non-limiting embodiments, the method may further include querying a database comprising a plurality of existing object data records.

In some non-limiting embodiments, the method may further include determining that the first object data associated with the at least one first component of the plurality of components of the lawn mower matches at least one existing object data record of the plurality of existing object data records. In some non-limiting embodiments, based on determining that the first object data associated with the at least one first component of the plurality of components of the lawn mower matches the at least one existing object data record of the plurality of existing object data records, the method may further include determining the second location underneath the second side of the lawn mower.

In some non-limiting embodiments, the method may include determining that the first object data associated with the at least one first component of the plurality of components of the lawn mower does not match at least one existing object data record of the plurality of existing object data records. In some non-limiting embodiments, based on determining that the first object data associated with the at least one first component of the plurality of components of the lawn mower does not match the at least one existing object data record of the plurality of existing object data records, the method may further include generating an object data record comprising the first object data associated with the at least one first component of the plurality of components of the lawn mower, updating the plurality of existing object data records of the database to include the object data record comprising the first object data associated with the at least one first component of the plurality of components of the lawn mower to provide an updated plurality of existing object data records, and/or determining the second location underneath the second side of the lawn mower based on the updated plurality of existing object data records.

In some non-limiting embodiments, the at least one second component of the plurality of components of the lawn mower may be a blade, where the task may include sharpening the blade.

Further non-limiting embodiments are set forth in the following numbered clauses:

Clause 1: An orientation system for a robot configured to orient the robot relative to a lawn mower comprising a plurality of components, comprising: a drive system configured to move the robot; at least one sensor; and at least one processor operatively connected to the drive system and the at least one sensor, the at least one processor configured to: determine first object data associated with at least one first component of the plurality of components of the lawn mower based on a first signal received from the at least one sensor, wherein the first signal is detected by the at least one sensor at a first location, wherein the first location is a location adjacent to a first side of the lawn mower; control the drive system to drive from the first location to a second location based on the first object data, wherein the second location is a location underneath a second side of the lawn mower; determine second object data associated with at least one second component of the plurality of components of the lawn mower based on a second signal received from the at least one sensor, wherein the second signal is detected by the at least one sensor at the second location underneath the second side of the lawn mower; and control the robot to perform a task based on the second object data associated with the at least one second component of the plurality of components of the lawn mower.

Clause 2: The orientation system of clause 1, wherein the at least one sensor comprises at least one second processor, and wherein the at least one second processor is configured to: detect at least one signal; and communicate the at least one signal to the at least one processor.

Clause 3: The orientation system of clause 1 or 2, wherein the at least one sensor comprises one of a light detection and ranging (LiDAR) sensor, a time-of-flight (ToF) sensor, a proximity sensor, an optical sensor, an image sensor, or any combination thereof.

Clause 4: The orientation system of any of clauses 1-3, wherein the drive system comprises at least one second processor, and wherein the at least one second processor is configured to: receive data from the at least one processor, the data comprising instructions to drive from the first location to the second location; and drive the robot from the first location to the second location in response to receiving the instructions.

Clause 5: The orientation system of any of clauses 1-4, wherein the drive system comprises at least one of a motor, a wheel, a ball, a track, and/or any combination thereof.

Clause 6: The orientation system of any of clauses 1-5, wherein the system further comprises at least one camera, wherein the at least one processor is further configured to: control the at least one camera to capture the first object data associated with at least one first component of the plurality of components of the lawn mower wherein the first object data is captured at the first location adjacent to the first side of the lawn mower.

Clause 7: The orientation system of any of clauses 1-6, wherein the at least one processor is further configured to: determine the second location underneath the second side of the lawn mower based on the first object data.

Clause 8: The orientation system of any of clauses 1-7, wherein the system further comprises a database, the database comprising a plurality of existing object data records, and wherein the at least one processor is further configured to: query the database to determine whether or not the first object data associated with the at least one first component of the plurality of components of the lawn mower matches at least one existing object data record of the plurality of existing object data records.

Clause 9: The orientation system of any of clauses 1-8, wherein based on determining that the first object data associated with the at least one first component of the plurality of components of the lawn mower matches the at least one existing object data record of the plurality of existing object data records, the at least one processor is configured to: determine the second location underneath the second side of the lawn mower.

Clause 10: The orientation system of any of clauses 1-9, wherein based on determining that the first object data associated with the at least one first component of the plurality of components of the lawn mower does not match the at least one existing object data record of the plurality of existing object data records, the at least one processor is configured to: generate an object data record comprising the first object data associated with the at least one first component of the plurality of components of the lawn mower; update the plurality of existing object data records to include the object data record comprising the first object data associated with the at least one first component of the plurality of components of the lawn mower to provide an updated plurality of existing object data records; and determine the second location underneath the second side of the lawn mower based on the updated plurality of existing object data records.

Clause 11: The orientation system of any of clauses 1-10, wherein the at least one second component of the plurality of components of the lawn mower is a blade, wherein the task comprises sharpening the blade.

Clause 12: A method for orienting a robot relative to a lawn mower, the robot comprising a drive system configured to move the robot, at least one sensor, and at least one processor operatively connected to the drive system and the at least one sensor, the lawn mower comprising a plurality of components, the method comprising: determining, by at least one processor, first object data associated with at least one first component of the plurality of components of the lawn mower based on a first signal received from the at least one sensor, wherein the first signal is detected by the at least one sensor at a first location, wherein the first location is a location adjacent to a first side of the lawn mower; controlling, by at least one processor, the drive system to drive from the first location to a second location based on the first object data, wherein the second location is a location underneath a second side of the lawn mower; determining, by at least one processor, second object data associated with at least one second component of the plurality of components of the lawn mower based on a second signal received from the at least one sensor, wherein the second signal is detected by the at least one sensor at the second location underneath the second side of the lawn mower; and controlling, by at least one processor, the robot to perform a task based on the second object data associated with the at least one second component of the plurality of components of the lawn mower.

Clause 13: The method of clause 12, wherein the at least one sensor comprises one of a light detection and ranging (LiDAR) sensor, a time-of-flight (ToF) sensor, a proximity sensor, an optical sensor, an image sensor, and/or any combination thereof.

Clause 14: The method of clause 12 or 13, wherein the drive system comprises at least one of a motor, a wheel, a ball, a track, and/or any combination thereof.

Clause 15: The method of any of clauses 12-14, wherein the robot further comprises at least one camera, the method further comprising: controlling, by at least one processor, the at least one camera to capture the first object data associated with at least one first component of the plurality of components of the lawn, wherein the first object data is captured at the first location adjacent to the first side of the lawn mower.

Clause 16: The method of any of clauses 12-15, further comprising: determining, by at least one processor, the second location underneath the second side of the lawn mower based on the first object data.

Clause 17: The method of any of clauses 12-16, further comprising: querying, by at least one processor, a database comprising a plurality of existing object data records.

Clause 18: The method of any of clauses 12-17, further comprising: determining, by at least one processor, that the first object data associated with the at least one first component of the plurality of components of the lawn mower matches at least one existing object data record of the plurality of existing object data records; and based on determining that the first object data associated with the at least one first component of the plurality of components of the lawn mower matches the at least one existing object data record of the plurality of existing object data records, determining, by at least one processor, the second location underneath the second side of the lawn mower.

Clause 19: The method of any of clauses 12-18, further comprising: determining, by at least one processor, that the first object data associated with the at least one first component of the plurality of components of the lawn mower does not match at least one existing object data record of the plurality of existing object data records; and based on determining that the first object data associated with the at least one first component of the plurality of components of the lawn mower does not match the at least one existing object data record of the plurality of existing object data records, generating, by at least one processor, an object data record comprising the first object data associated with the at least one first component of the plurality of components of the lawn mower; updating, by at least one processor, the plurality of existing object data records of the database to include the object data record comprising the first object data associated with the at least one first component of the plurality of components of the lawn mower to provide an updated plurality of existing object data records; and determining, by at least one processor, the second location underneath the second side of the lawn mower based on the updated plurality of existing object data records.

Clause 20: The method of any of clauses 12-19, wherein the at least one second component of the plurality of components of the lawn mower is a blade, wherein the task comprises sharpening the blade.

These and other features and characteristics of the present disclosure, as well as the methods of operation and functions of the related elements of structures and the combination of parts and economics of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for a robot configured to orient the robot relative to a lawn mower, according to some non-limiting embodiments;

FIG. 2 is a flow diagram of a method for orienting a robot relative to a lawn mower, according to some non-limiting embodiments;

FIGS. 3A and 3B are diagrams of a robot, according to some non-limiting embodiments;

FIG. 3C is a schematic diagram of example hardware components of the robot in FIGS. 3A and 3B, according to some non-limiting embodiments;

FIG. 4 is a diagram of a lawn mower, according to some non-limiting embodiments;

FIGS. 5A-5D are exemplary diagrams of the system of FIG. 1, according to some non-limiting embodiments; and

FIG. 6 is an exemplary graphical user interface (GUI) displaying data associated with the system of FIG. 1, according to some non-limiting embodiments.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments of the disclosed subject matter. Hence, specific dimensions and other physical characteristics related to the embodiments disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments, refer to a condition for automatically triggering an action (e.g., a specific operation of an electronic device, such as a computing device, a processor, and/or the like).

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

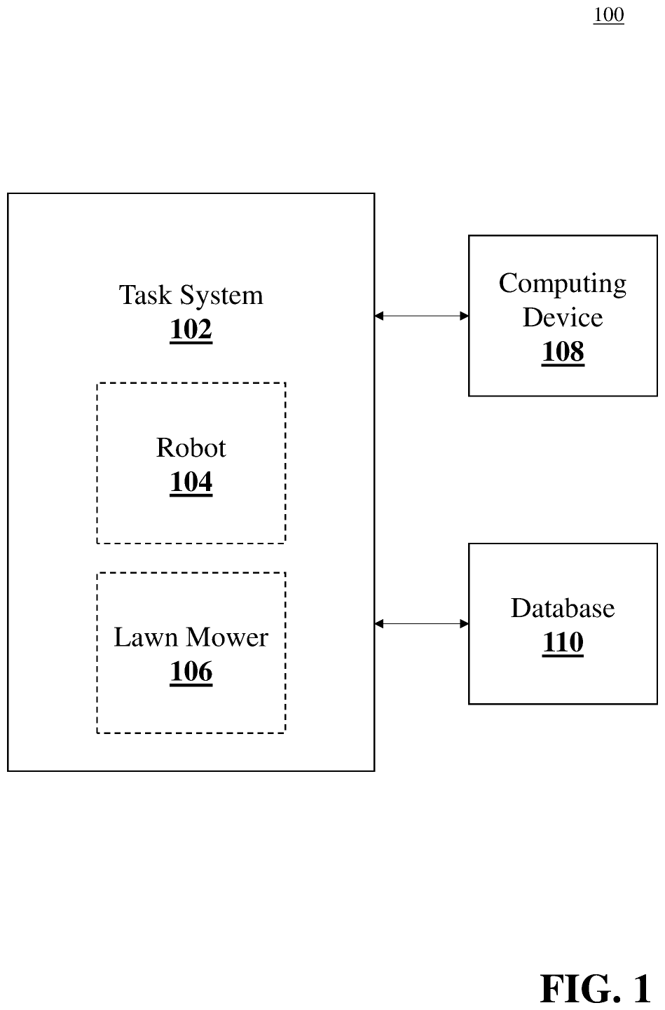

Referring now to FIG. 1, shown is a schematic diagram of a system 100 for a robot configured to orient the robot relative to a lawn mower, according to some non-limiting embodiments. System 100 may include task system 102, computing device 108, and/or database 110. Task system 102, computing device 108, and/or database 110 may interconnect (e.g., establish a connection to communicate) via wired connections, wireless connections, or a combination of wired and wireless connections.

Task system 102 may include one or more devices configured to communicate with computing device 108 and/or database 110. For example, task system 102 may include a server, a group of servers, and/or other like devices. In some non-limiting embodiments, task system 102 may be in communication with a data storage device (e.g., database 110), which may be local or remote to task system 102. In some non-limiting embodiments, task system 102 may be capable of receiving information from, storing information in, transmitting information to, and/or searching information stored in the data storage device (e.g., database 110). In some non-limiting embodiments, task system 102 may include lawn mower robot 104 and/or lawn mower 106.

Robot 104 may include a computing device, as described herein. Robot 104 may include one or more devices configured to communicate with computing device 108 and/or database 110. In some non-limiting embodiments, robot 104 may be in communication with a data storage device (e.g., database 110), which may be local or remote to robot 104. In some non-limiting embodiments, robot 104 may be capable of receiving information from, storing information in, transmitting information to, and/or searching information stored in the data storage device (e.g., database 110). In some non-limiting embodiments, robot 104 may include an autonomous lawn mower blade sharpening and task apparatus, as described in U.S. Patent Application Publication No. US-2021-0007281-A1, filed on Jul. 14, 2020, the disclosure of which is hereby incorporated by reference in its entirety.

In some non-limiting embodiments, lawn mower 106 may be any type of lawn mower configured to cut grass (e.g., manual push, electric, riding, etc.). In some non-limiting embodiments, lawn mower 106 may include a plurality of components. In some non-limiting embodiments, lawn mower 106 may include a Radio Frequency Identification (RFID) (e.g., a tag or embedding) which may be scanned and/or read by task system 102, robot 104, computing device 108, and/or database 110.

Computing device 108 may include a computing device configured to communicate with task system 102 and/or database 110 (e.g., via a wired or wireless connection). For example, computing device 108 may include a computing device, such as a server, a desktop computer, a portable computer (e.g., tablet computer, a laptop computer, and/or the like), a mobile device (e.g., a cellular phone, a smartphone, a personal digital assistant, a wearable device, and/or the like), and/or other like devices. In some non-limiting embodiments, system 100 may include one or more subsequent computing devices that are the same as, similar to, and/or part of computing device 108.

Database 110 may include one or more devices configured to communicate with task system 102 and/or computing device 108 (e.g., via a wired or wireless connection). For example, database 110 may include a computing device, such as a server, a group of servers, and/or other like devices.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

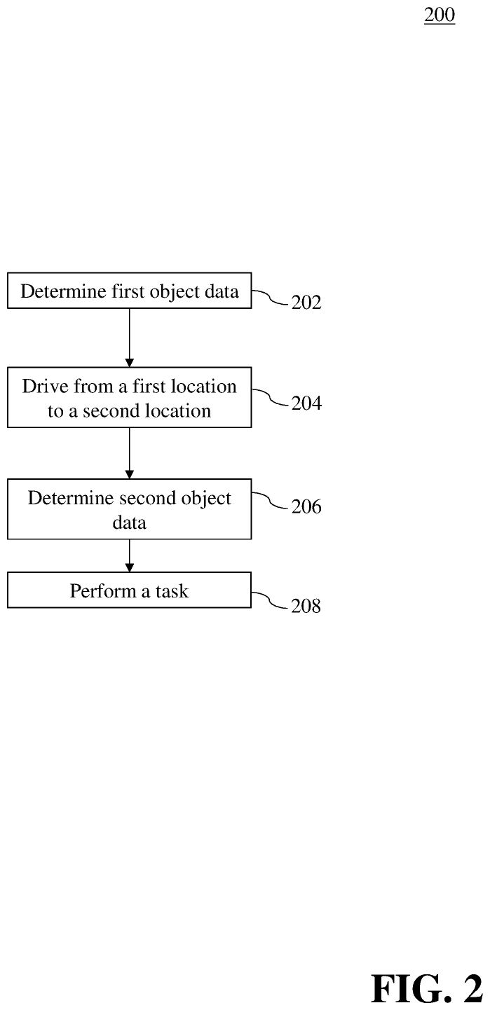

Referring to FIG. 2, shown is a flow diagram of a method 200 for orienting a robot relative to a lawn mower, according to some non-limiting embodiments. In some non-limiting embodiments, one or more steps of method 200 may be performed (e.g., completely, partially, etc.) by task system 102 (e.g., one or more devices of task system 102). In some non-limiting embodiments, one or more steps of method 200 may be performed (e.g., completely, partially, etc.) by another device or group of devices separate from or task system 102.

In some non-limiting embodiments, task system 102 may include at least one processor. For example, robot 104 may include at least one processor. In some non-limiting embodiments, robot 104 may include a drive system configured to move the robot and/or at least one sensor. In some non-limiting embodiments, the at least one processor may be operatively connected to the drive system and/or the at least one sensor. In some non-limiting embodiments, the at least one processor may be configured to control the drive system and/or the at least one sensor. In some non-limiting embodiments, the drive system and/or the at least one sensor may include at least one second processor.

In some non-limiting embodiments, task system 102 may generate and/or communicate instructions (e.g., to robot 104). For example, task system 102 may generate and/or communicate instructions comprising data instructing robot 104 to activate (e.g., turn on) and/or deactivate (e.g., turn off). In some non-limiting embodiments, task system 102 may activate robot 104. Robot 104 may be activated in a first location, where the first location is adjacent to (e.g., next to) lawn mower 106. The first location may be a location relative to lawn mower 106 (e.g., to the left, right, front, and/or back of lawn mower 106).

In some non-limiting embodiments, lawn mower 106 may include a plurality of components. The plurality of components may include at least one of a body, a deck, a discharge chute, a wheel, and/or a blade. In some non-limiting embodiments, lawn mower 106 may include six sides (e.g., a front, a back, a top, a bottom, a left, and a right). In some non-limiting embodiments, lawn mower 106 may include a Radio Frequency Identification (RFID). For example, an RFID chip may be attached to and/or embedded in one or more components of lawn mower 106. In some non-limiting embodiments, robot task system 102 may scan and/or read the RFID chip of lawn mower 106.

In some non-limiting embodiments, task system 102 may detect, generate, and/or communicate at least one signal. For example, robot 104 may include at least one sensor configured to detect, generate, and/or communicate (e.g., to the at least one processor) at least one signal and/or data associated with the at least one signal. In some non-limiting embodiments, task system 102 may control the at least one sensor to detect, generate, and/or communicate the at least one signal and/or data associated with the at least one signal.

In some non-limiting embodiments, task system 102 may detect a first signal associated with at least one first component of the plurality of components of the lawn mower. For example, the at least one sensor of robot 104 may detect the first signal at the first location (e.g., to the front, back, right, or left of lawn mower 106).

In some non-limiting embodiments, the at least one first component may include a body of the lawn mower, a deck of the lawn mower, a discharge chute of the lawn mower, a wheel of the lawn mower, a blade of the lawn mower, and/or any other component of the lawn mower. In some non-limiting embodiments, task system 102 may determine a position of robot 104 (e.g., relative to lawn mower 106) and/or lawn mower 106 (e.g., relative to robot 104) based on the at least one first component.

As shown in FIG. 2, at step 202, method 200 may include determining the first object data. For example, task system 102 may determine first object data associated with the at least one first component of the plurality of components of the lawn mower based on the first signal received from the at least one sensor.

In some non-limiting embodiments, task system 102 may determine the first object data associated with the at least one first component of the plurality of components of the lawn mower based on the first signal received from the at least one sensor.

In some non-limiting embodiments, the first object data may include a dimension (e.g., a length, a width, and/or a height) of the at least one first component, a distance between robot 104 and the at least one first component, a location of the at least one first component, a type of component of the at least one first component, a task associated with the at least one first component, and/or other details associated with the at least one first component.

In some non-limiting embodiments, task system 102 may include at least one camera. For example, robot 104 may include the at least one camera. In some non-limiting embodiments, the at least one processor may be operatively connected to the at least one camera. In some non-limiting embodiments, the at least one processor may be configured to control the at least one camera. In some non-limiting embodiments, the at least one camera may include at least one second processor.

In some non-limiting embodiments, task system 102 may capture first object data associated with at least one first component of the plurality of components of the lawn mower (e.g., in response to detecting the first object data associated with at least one first component of the plurality of components of the lawn mower). For example, task system 102 may control the at least one camera to capture the first object data.

In some non-limiting embodiments, task system 102 may query a database, the database including a plurality of existing object data records. The existing object data records may include data associated with the plurality of components of lawn mower 106 and/or a second plurality of components associated with a plurality of lawn mowers. In some non-limiting embodiments, task system 102 may query the database to determine whether or not the first object data associated with the at least one first component of the plurality of components of the lawn mower matches at least one existing object data record of the plurality of existing object data records. In some non-limiting embodiments, task system 102 may query the at least one database based on the first signal received from the at least one sensor and/or based on the first object data captured by the at least one camera.

In some non-limiting embodiments, task system 102 may compare the first object data (e.g., one or more features of the first object data) to the plurality of existing object data records (e.g., to one or more features of the plurality of existing object data records) to identify a match and/or a partial match. In some non-limiting embodiments, task system 102 may determine whether or not the first object data associated with the at least one first component of the plurality of components of the lawn mower matches at least one existing object data record of the plurality of existing object data records based on the comparison. In some non-limiting embodiments, if task system 102 identifies a match, then task system 102 may determine that the first object data associated with the at least one first component of the plurality of components of the lawn mower matches at least one existing object data record of the plurality of existing object data records. In some non-limiting embodiments, if task system 102 does not identify a match, then task system 102 may determine that the first object data associated with the at least one first component of the plurality of components of the lawn mower does not match at least one existing object data record of the plurality of existing object data records.

In some non-limiting embodiments, if task system 102 determines that the first object data associated with the at least one first component of the plurality of components of the lawn mower matches the at least one existing object data record of the plurality of existing object data records, then task system 102 may determine a second location. For example, if task system 102 determines that the first object data matches at least one existing object data record (e.g., task system 102 recognizes an environment surrounding robot 104), then task system 102 may determine a second location (e.g., different from the first location) and control robot 104 to move to the second location. In some non-limiting embodiments, the second location may be relative to lawn mower 106 (e.g., a location underneath the bottom side of lawn mower 106).

In some non-limiting embodiments, if task system 102 determines that the first object data associated with the at least one first component of the plurality of components of the lawn mower does not match the at least one existing object data record of the plurality of existing object data records, then task system 102 may generate an object data record comprising the first object data associated with the at least one first component of the plurality of components of the lawn mower. In some non-limiting embodiments, task system 102 may update (e.g., automatically) the plurality of existing object data records to include the object data record comprising the first object data associated with the at least one first components of the plurality of components of the lawn mower to provide an updated plurality of existing object data records. In some non-limiting embodiments, task system 102 may determine the second location based on the updated plurality of existing object data records.

As shown in FIG. 2, at step 204, method 200 may include driving from the first location to the second location. For example, robot 104 may drive from the first location to the second location based on the first object data. In some non-limiting embodiments, task system 102 may control the drive system to drive robot 104 from the first location to the second location based on the first object data. In some non-limiting embodiments, the second location may include a location underneath a second side (e.g., the bottom) of lawn mower 106. In some non-limiting embodiments, one or more components of lawn mower 106 (e.g., the blades) may only be accessible to robot 104 from a location underneath the second side (e.g., the bottom) of lawn mower 106.

In some non-limiting embodiments, the at least one second processor of the drive system may receive data from task system 102 including instructions to drive from the first location to the second location. In some non-limiting embodiments, the drive system may be configured to drive the robot from the first location to the second location in response to receiving the instructions. In some non-limiting embodiments, the drive system may include at least one of a motor, a wheel, a ball, a track, and/or any combination thereof.

In some non-limiting embodiments, task system 102 may detect a second signal associated with at least one second component of the plurality of components of the lawn mower. For example, the at least one sensor of robot 104 may detect the second signal at the second location. In some non-limiting embodiments, the at least one second component may include a body, a deck, a discharge chute, a wheel, a blade and/or any other component of lawn mower 106.

As shown in FIG. 2, at step 206, task system 102 may determine the second object data. For example, task system 102 may determine the second object data associated with the at least one second component of the plurality of components of the lawn mower based on the second signal received from the at least one sensor and/or based on the second object data captured by the at least one camera.

In some non-limiting embodiments, the second object data may include a dimension (e.g., a length, a width, and/or a height) of the at least one second component, a distance between robot 104 and the at least one second component, a location of the at least one second component, a type of component of the at least one second component, a task associated with the at least one second component, and/or other details associated with the at least one second component.

In some non-limiting embodiments, task system 102 may capture (e.g., using the at least one camera) second object data associated with at least one second component of the plurality of components of lawn mower 106, as described herein. In some non-limiting embodiments, task system 102 may capture the second object data associated with at least one second component of the plurality of components of lawn mower 106 in response to detecting the second object data associated with at least one second component of the plurality of components of the lawn mower.

In some non-limiting embodiments, task system 102 may query the database to determine whether or not the second object data associated with the at least one second component of the plurality of components of the lawn mower matches at least one existing object data record of the plurality of existing object data records, as described herein.

In some non-limiting embodiments, if task system 102 determines that the second object data associated with the at least one second component of the plurality of components of the lawn mower matches the at least one existing object data record of the plurality of existing object data records, then task system 102 may determine a third location underneath the bottom side of the lawn mower. In some non-limiting embodiments, the second location and/or the third location may be the location where a task may be completed.

In some non-limiting embodiments, the third location may be a location that is different from the second location or the same as the second location (e.g., robot 104 will not move). In some non-limiting embodiments, the third location may be a location that is the same as the first location (e.g., robot 104 will return from the second location to the first location if task system 102 determines that the task does not need to be completed based on the first object data and/or the second object data).

In some non-limiting embodiments, if task system 102 determines that the second object data associated with the at least one second component of the plurality of components of the lawn mower does not match the at least one existing object data record of the plurality of existing object data records, then task system 102 may generate an object data record comprising the second object data associated with the at least one second component of the plurality of components of the lawn mower. In some non-limiting embodiments, task system 102 may update the plurality of existing object data records to include the object data record comprising the second object data associated with the at least one second components of the plurality of components of the lawn mower to provide an updated plurality of existing object data records. In some non-limiting embodiments, task system 102 may determine the third location underneath the second side of lawn mower 106 based on the updated plurality of existing object data records.

In some non-limiting embodiments, task system 102 may detect a plurality of signals associated with the plurality of components of lawn mower 106, as described herein. In some non-limiting embodiments, task system 102 may capture object data associated with the plurality of components of lawn mower 106, as described herein.

As shown in FIG. 2, at step 208, task system 102 may perform a task. In some non-limiting embodiments, task system 102 may control robot 104 to perform the task based on the first object data associated with the at least one first component of the plurality of components of lawn mower 106 and/or the second object data associated with the at least one second component of the plurality of components of lawn mower 106. In some non-limiting embodiments, the task may include a series of tasks (e.g., sharpening the blades of lawn mower 106 and/or other lawn mower service and/or maintenance tasks).

In some non-limiting embodiments, robot 104 may include at least one task arm configured to perform the task. In some non-limiting embodiments, the at least one task arm may be operatively connected to the at least one processor. In some non-limiting embodiments, the at least one task arm may include at least one second processor. The at least one task arm may be removable, static, and/or motorized. Task system 102 may control the at least one task arm to perform the task. In some non-limiting embodiments, the task may include sharpening at least one blade of lawn mower 106. For example, task system 102 may control the task arm of robot 104 to sharpen at least one blade of lawn mower 106.

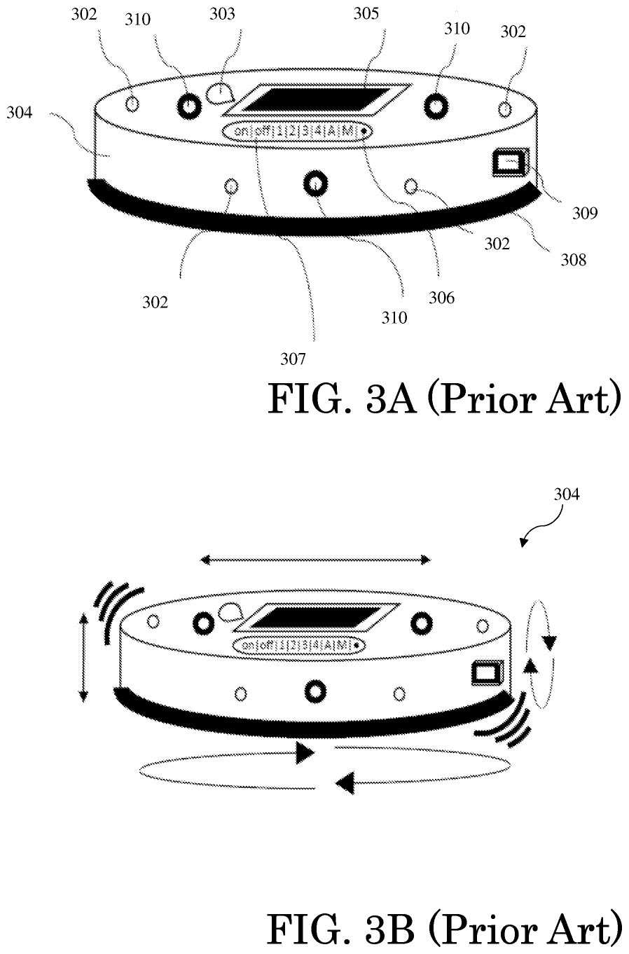

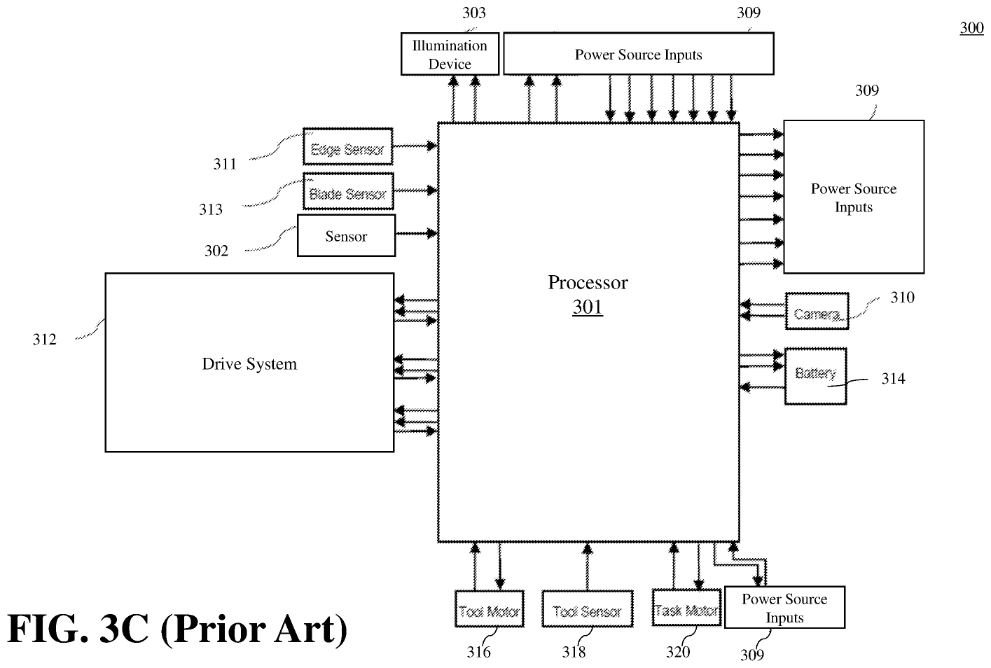

FIGS. 3A and 3B are diagrams of robot 304, according to some non-limiting embodiments. In some non-limiting embodiments, robot 304 may be the same as, similar to, and/or part of robot 104. In some non-limiting embodiments, robot 304 may include a plurality of components. In some non-limiting embodiments, the plurality of components may be operatively connected to at least one processor. In some non-limiting embodiments, the plurality of components may be configured to receive data from and/or communicate data to the at least one processor. In some non-limiting embodiments, the plurality of components of robot 304 may include sensor 302, illumination device 303, base 305, indicator 306, panel 307, duster 308, and power source input 309, and/or at least one camera 310.

In some non-limiting embodiments, sensor 302 may include one or more sensors. The one or more sensors may include light detection and ranging (LiDAR) sensor(s), time-of-flight (ToF) sensor(s), proximity sensor(s), optical sensor(s), image sensor(s), or any combination thereof. In some non-limiting embodiments, sensor 302 may detect at least one signal. For example, sensor 302 may be configured to detect at least one signal associated with at least one component of a plurality of components of lawn mower 106. In some non-limiting embodiments, sensor 302 may be operatively connected to at least one processor. In some non-limiting embodiments, sensor 302 may be configured to communicate the at least one signal to the at least one processor.

In some non-limiting embodiments, illumination device 303 may include a light (e.g., an LED light) and/or a speaker. Illumination device 303 may be configured to generate, transmit, and/or receive data (e.g., visualization, voice commands, and/or loud noise response). For example there is a loud noise, such as lawn mower 106 starting up or running, the robot 304 may be configured to autonomously drive away from lawn mower 106.

In some non-limiting embodiments, base 305 may include a task tool (e.g., a task arm) and/or solar panel. In some non-limiting embodiments, base 305 may be replaceable, modular, motorized, and/or static. In some non-limiting embodiments, base 305 may include a depression configured to catch any falling debris, thereby providing for easy cleaning and less debris spread, as well as a location to store task tools and task tips not in use.

In some non-limiting embodiments, indicator 306 may include an LED light. Indicator 306 may be configured to light up to indicate various possible features of the robot 304, such as, e.g., robot power, program(s), settings, task input, and/or mode.

In some non-limiting embodiments, panel 307 may include buttons, battery power, signal strength, dials, and/or other indications which will provide various options for programs, settings, on/off, LED, and/or user inputs.

In some non-limiting embodiments, duster 308 may be configured to capture and/or move debris. Duster 308 may be configured to push debris out of the path of the robot 1 in order to keep it from becoming caught, traveling under, or otherwise inhibiting the progress of the robot 1 in all direction.

In some non-limiting embodiments, power source input 309 may be configured for use with one or more of power cables, USB cables, cable input sources, device receivers, remote receivers, external device receivers, and/or other cables to otherwise control or program robot 304 externally, wirelessly, and/or controlled by an owner/user.

In some non-limiting embodiments, camera 310 may be configured to perform an optimal alignment of task arm(s) and/or task tip(s) for precision accuracy in task(s). In some non-limiting embodiments, camera 310 may be configured to capture object data associated with a plurality of components of lawn mower 106. For example, the at least one processor may control camera 310 to capture object data associated with a plurality of components of lawn mower 106.

In some non-limiting embodiments, robot 304 may include components which may or may not be round and/or square and/or oval and/or a geometric shape and/or any shape and/or any color and/or any material and/or any height and/or any width and/or any circumference. Specifically, referring to FIG. 3A, robot 304 is shown as viewed in a normal state. Robot 304 may be formed by various shapes, sizes, colors, weights, heights, widths, and/or design.

In some non-limiting embodiments, robot 304 may include drive system 312 (shown in FIG. 3C). In some non-limiting embodiments the drive system may include one or more motors, wheels, balls, tracks, and/or any combination thereof. The drive system may include at least one brake and/or actuator. The brake and/or actuator may be configured to steer, stop, elevate, and/or descend robot 304. In some non-limiting embodiments, the brake and/or actuator may cause robot 304 to lock into place, pivot, counter act vibration (e.g., anti-vibration), and/or counter-balance.

In some non-limiting embodiments, wheels may be provided for the purposes of moving the robot in any direction at a speed. In some non-limiting embodiments, the speed may be controlled by programming, a device, and/or set by a user. Alternatively, one or more tracks may be utilized in lieu of, or in addition to, the wheels. Alternatively, a ball or track may be used in place the wheels.

As shown in FIG. 3B, robot 304 may move in any direction (e.g., front, back, diagonally, side-to-side) and/or rotate (e.g., 360 degrees). In some non-limiting embodiments, robot 304 may move around and/or encircle an object (e.g., a lawn mower 106).

In some non-limiting embodiments, robot 304 may be configured to move from a first location to a second location. In some non-limiting embodiments, robot 304 may be configured to move between, under, and/or around one or more lawn mowers.

Referring now to FIG. 3C, shown is a schematic diagram of example hardware components of robot 304, according to some non-limiting embodiments. In some non-limiting embodiments, robot 304 may include at least one processor 301. In some non-limiting embodiments, processor 301 may include an 8-bit processor. In some non-limiting embodiments, one or more components of robot 304 may include at least one second processor (not shown).

In some non-limiting embodiments, robot 304 may include one or more sensors. For example, robot 304 may include sensor 302, edge sensor 311, blade sensor 313, and/or tool sensor 318. In some non-limiting embodiments, processor 301 may be operatively connected to the one or more sensors. For example, processor 301 may be operatively connected to and/or control at least one of sensor 302, edge sensor 311, blade sensor 313, and/or tool sensor 318. In some non-limiting embodiments, at least one of sensor 302, edge sensor 311, blade sensor 313, and/or tool sensor 318 may include light detection and ranging (LIDAR) device(s), object detection system(s), Time-of-flight (ToF) sensor(s), and/or other various sensor(s), lasers, and/or various other approximation and/or detection apparatuses, and/or any combination thereof.

Processor 301 may be operatively connected to one or more systems or devices. For example, processor 301 may be operatively connected to and/or control illumination device 303, camera 310, drive system 312 (e.g., one or more components of drive system 312), battery 314, tool motor 316, and/or ask motor 320.

Processor 301 may be operatively connected to one or more power source inputs 309 (e.g., Power LED, User Button, User Button LEDs, and USB). In some non-limiting embodiments, power source input 309 may be configured to connect to: power cables, USB cables, other cable input sources, device receivers, remote receivers, external device receivers, and/or other cables to otherwise control or program the robot externally, wirelessly, and/or controlled by an owner.

In some non-limiting embodiments, drive system 312 may be configured to move the robot in any direction at a speed controlled by programming, device, owner, and/or settings. One or more wheels, balls, and/or tracks may be provided to assist in the steering and mobile refinement for lining up robot 304 for tasks in an accurate fashion and/or general motion purposes.

In some non-limiting embodiments, edge sensor 311 may be connected to at least one task tip (not shown) of robot 304. In some non-limiting embodiments, the task tip may be integrated into the task arm, replaceable from the task arm, removable from the task arm, modular in relation to the task arm able to accommodate multiple different and/or similar task tips as a single tip and/or multiple tips at the same time and/or in conjunction with each other.

Further details regarding robot 304 (e.g., a lawn mower blade sharpening and task apparatus) are described in U.S. Patent Application Publication No. US-2021-0007281-A1, filed on Jul. 14, 2020, the disclosure of which is hereby incorporated by reference in its entirety.

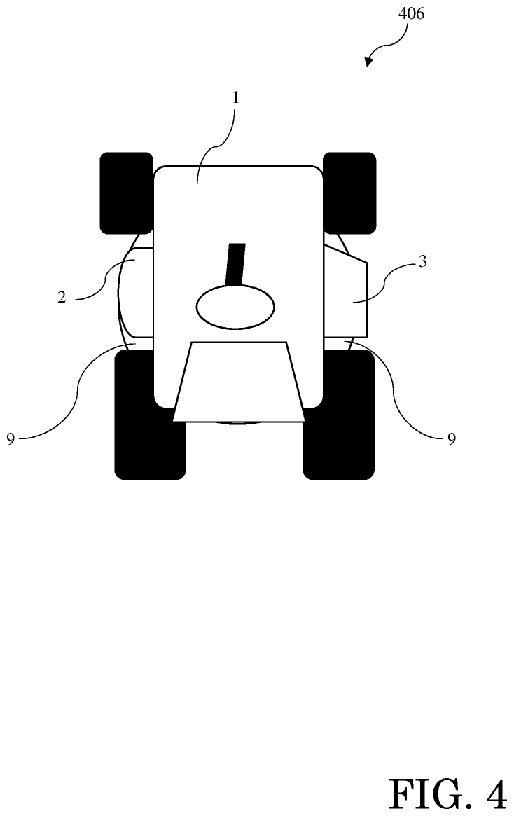

Referring now to FIG. 4, shown is a diagram of lawn mower 406, according to some on-limiting embodiments. Lawn mower 406 may be the same as, similar to, and/or part of lawn mower 106. In some non-limiting embodiments, lawn mower 406 may include body 1, deck 2, discharge chute 3, and/or wheels 12. Lawn mower 406 may be a riding mower, a push mower, an electric mower, a gas mower, a battery-powered mower, and/or any combination thereof.

In some non-limiting embodiments, body 1 may include 6 sides (e.g., a top side, a bottom side, a front side, a back side, a left side, and a right side). In some non-limiting embodiments, deck 2 and/or discharge chute 3 may be attached to body 1 (e.g., on any of the 6 sides of body 1). For example, deck 2 and/or discharge chute 3 may be attached to body 1 on any of the top side, bottom side, front side, back side, left side, and/or right side of body 1. In some non-limiting embodiments, wheels 12 may be attached to body 1 on the right and/or left side of body 1 at the front side of body 1 and or the back side of body 1.

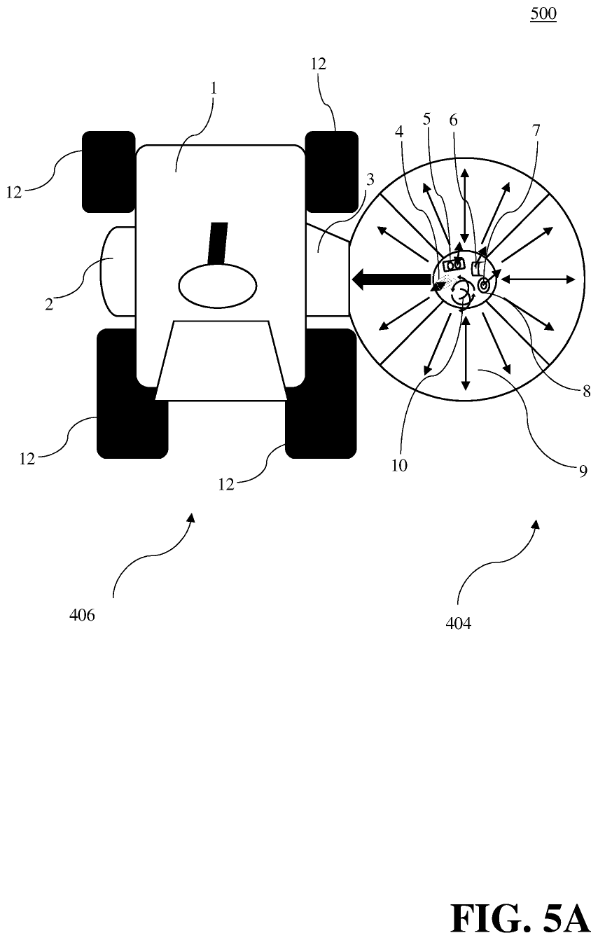

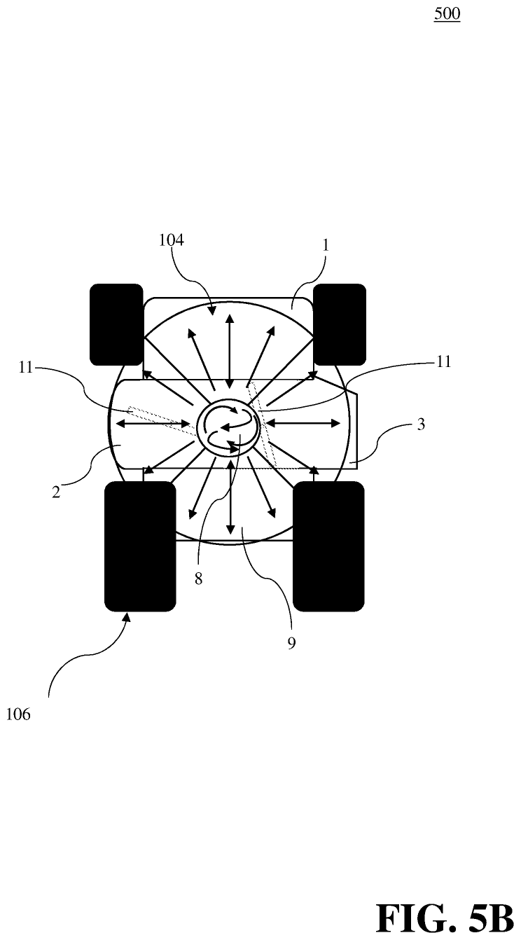

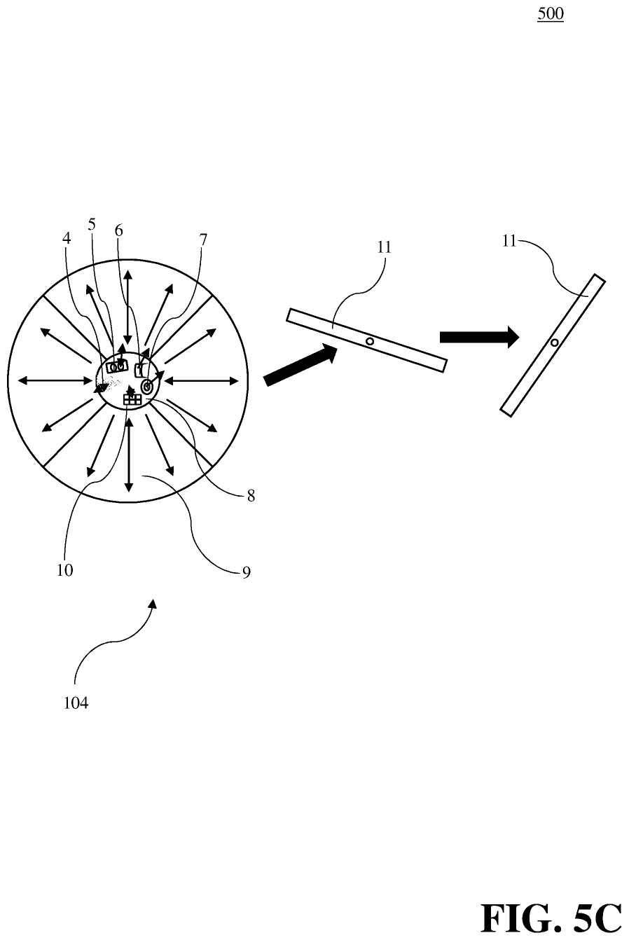

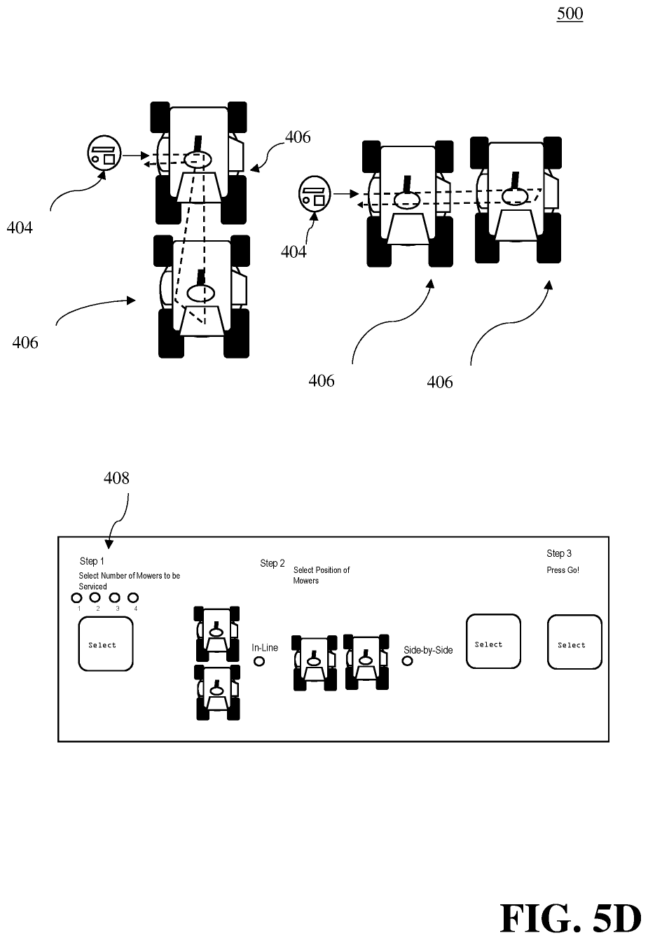

Referring now to FIGS. 5A-5D, shown are diagrams of a system 500 for a robot configured to orient the robot relative to a lawn mower comprising a plurality of components, according to some non-limiting embodiments. In some non-limiting embodiments, system 500 may include robot 404 and/or lawn mower 406. In some non-limiting embodiments, robot 404 may be the same as, similar to, and/or part of robot 104 and/or robot 304.

As shown in FIG. 5A, robot 404 may include lawn mower blade sharpening and task apparatus 8. In some non-limiting embodiments, robot 404 may include system devices 4-7. For example, lawn mower blade sharpening and task apparatus 8 may include system devices 4-7. In some non-limiting embodiments, system devices 4-7 may include a light detection and ranging (LIDAR) device(s), object detection device(s), computation device(s), sensor(s), camera(s), illumination device(s), pixel(s), and/or laser(s). In some non-limiting embodiment, computation device(s) may include at least on processor and/or memory. In some non-limiting embodiments, the computation device(s) may be configured to compute algorithms. In some non-limiting embodiments, computation device(s) may include Artificial Intelligence (AI) device(s) and/or Machine Learning model(s). In some non-limiting embodiments, computation device(s) may be configured to generate one or more machine learning model(s). In some non-limiting embodiments, sensor(s) may include Time-of-Flight (ToF) sensor(s), and/or various sensor(s). In some non-limiting embodiments, laser(s) may include cross-hair laser(s). In some non-limiting embodiments, robot 104 may include other approximation devices, and/or other detection devices.

In some non-limiting embodiments, robot 404 may be configured to move in a plurality of directions and/or within a plurality of ranges 9. In some non-limiting embodiments, the plurality of directions and/or the plurality of ranges 9 may be specified (e.g., set by a user) and/or programmable.

In some non-limiting embodiments, robot 404 may calibrate and/or gain orientation. For example, robot 404 may calibrate and/or gain orientation based on a location of lawn mower 406. In some non-limiting embodiments, robot 404 may be configured to rotate (e.g., spin) in direction 10. For example, robot 404 may rotate (e.g., 360 degrees) in direction 10 to gain orientation and/or encircle (e.g., fully or partially) lawn mower 106 in order to gain orientation. In some non-limiting embodiments, robot 404 may maintain a single position (e.g., stay still) in order to gain orientation.

In some non-limiting embodiments, robot 104 may be activated (e.g., turned on/turned off). For example, robot 404 may be activated based on a timing (e.g., a specified time interval) and/or a positioning of robot 404. In some non-limiting embodiments, activation of system 500 may be manual, controlled via an app, controlled via app/device combination, autonomous, remote controlled (e.g., via a wired or wireless connection), and/or any combination thereof.

Robot 404 may be configured to operate within range 9 based on a location of lawn mower 406. For example, robot 404 may be configured to operate directly below the bottom side of body 1 within range 9.

FIG. 5B shows a perspective of an underside of lawn mower 406, looking up to the underside of lawn mower 406. As shown in FIG. 5B, robot 404 may operate below lawn mower 406 at the bottom side of body 1.

As shown in FIGS. 5B and 5C, lawn mower 406 may include blades 11. In some non-limiting embodiments, blades 11 may be attached to lawn mower 406 at the bottom of side body 1. In some non-limiting embodiments, lawn mower 406 may include one blade, two blades, or any number of blades. In some non-limiting embodiments, blades 11 may be attached to the bottom side of body 1 via any attachment mechanism (e.g., a screw).

In some non-limiting embodiments, robot 404 may be configured to sharpen blades 11. For example, lawn mower blade sharpening and task apparatus may be configured to sharpen blades 11. In some non-limiting embodiments, robot 404 may generate and communicate instructions to the lawn mower blade sharpening and task apparatus.

As show in FIG. 5D, robot 404 may move from a first mower 406 to a second mower 406 when the lawn mowers 406 are in-line, side-by-side, and/or scattered. In some non-limiting embodiments, robot 404 may move from a first lawn mower 406 to a second lawn mower 406.

In some non-limiting embodiments, robot 404 may include a display. For example, robot 404 may display data associated with graphical user interface (GUI) 408 via the display. In some non-limiting embodiments, GUI 408 may be an interactive GUI. In some non-limiting embodiments, a user may input configuration data to robot 404 and/or computer device 108 via GUI 408. The configuration data may include data associated with lawn mower 406 (e.g., a position of a first lawn mower 406 relative to a second lawn mower 406).

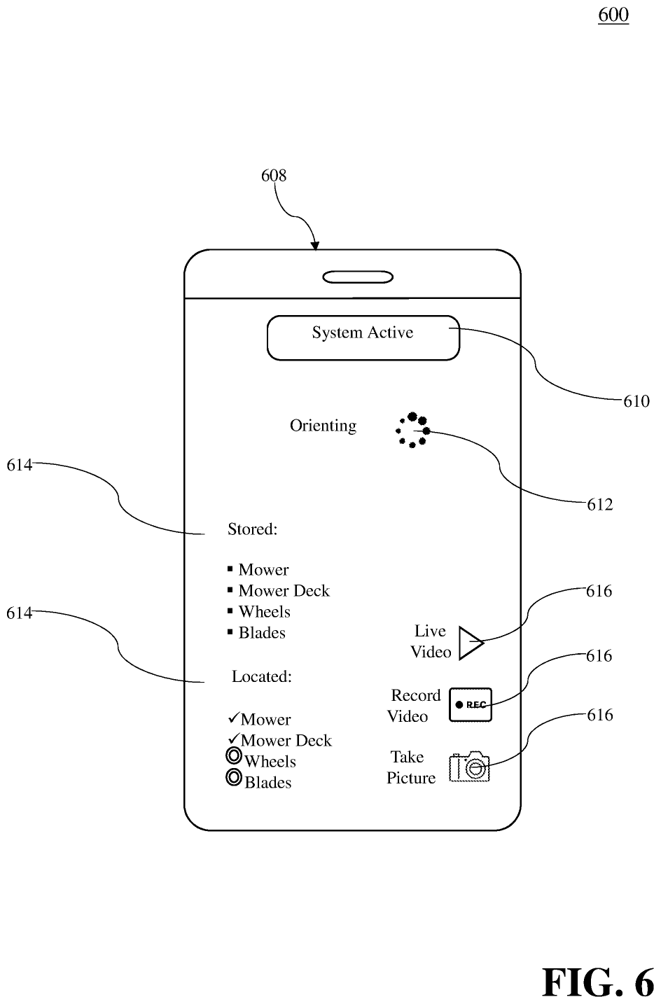

Referring to FIG. 6, shown is an exemplary GUI 600 displaying data associated with task system 102, according to some non-limiting embodiments.

In some non-limiting embodiments, computing device 608 may be the same as, similar to, and/or part of computing device 108. In non-limiting embodiments, computing device 608 may display GUI 600 via a display of computing device 608. In some non-limiting embodiments, GUI 600 may display data associated with lawn mower 106 and/or robot 104. For example, GUI 600 may display data associated with actions, orientation, acclimation, navigation, location, and overall occurrences of task system 102.

In some non-limiting embodiments, GUI 600 may display data associated with an activation state 610 of robot 104. In some non-limiting embodiments GUI 600 may display data associated with a status 612 of robot 104. In some non-limiting embodiments GUI 600 may display data associated with actions 614. Actions 614 may include actions taken, queried, and/or known to robot 104. In some non-limiting embodiments, GUI 600 may display data associated with future actions 616 (e.g., play live video, record video, and/or take picture).

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. An orientation system for a robot configured to orient the robot relative to a lawn mower comprising a plurality of components, comprising:
a drive system configured to move the robot;
at least one sensor; and
at least one processor operatively connected to the drive system and the at least one sensor, the at least one processor configured to:
determine first object data associated with at least one first component of the plurality of components of the lawn mower based on a first signal received from the at least one sensor, wherein the first signal is detected by the at least one sensor at a first location, wherein the first location is a location adjacent to a first side of the lawn mower;
control the drive system to drive from the first location to a second location based on the first object data, wherein the second location is a location underneath a second side of the lawn mower;
determine second object data associated with at least one second component of the plurality of components of the lawn mower based on a second signal received from the at least one sensor, wherein the second signal is detected by the at least one sensor at the second location underneath the second side of the lawn mower; and
control the robot to perform a task based on the second object data associated with the at least one second component of the plurality of components of the lawn mower.

2. The orientation system of claim 1, wherein the at least one sensor comprises at least one second processor, and wherein the at least one second processor is configured to:
detect at least one signal; and
communicate the at least one signal to the at least one processor.

3. The orientation system of claim 2, wherein the at least one sensor comprises one of a light detection and ranging (LiDAR) sensor, a time-of-flight (ToF) sensor, a proximity sensor, an optical sensor, an image sensor, or any combination thereof.

4. The orientation system of claim 1, wherein the drive system comprises at least one second processor, and wherein the at least one second processor is configured to:
receive data from the at least one processor, the data comprising instructions to drive from the first location to the second location; and
drive the robot from the first location to the second location in response to receiving the instructions.

5. The orientation system of claim 4, wherein the drive system comprises at least one of a motor, a wheel, a ball, a track, and/or any combination thereof.

6. The orientation system of claim 1, wherein the system further comprises at least one camera, wherein the at least one processor is further configured to:
control the at least one camera to capture the first object data associated with at least one first component of the plurality of components of the lawn mower wherein the first object data is captured at the first location adjacent to the first side of the lawn mower.

7. The orientation system of claim 1, wherein the at least one processor is further configured to:
determine the second location underneath the second side of the lawn mower based on the first object data.

8. The orientation system of claim 1, wherein the system further comprises a database, the database comprising a plurality of existing object data records, and wherein the at least one processor is further configured to:
query the database to determine whether or not the first object data associated with the at least one first component of the plurality of components of the lawn mower matches at least one existing object data record of the plurality of existing object data records.

9. The orientation system of claim 8, wherein based on determining that the first object data associated with the at least one first component of the plurality of components of the lawn mower matches the at least one existing object data record of the plurality of existing object data records, the at least one processor is configured to:
determine the second location underneath the second side of the lawn mower.

10. The orientation system of claim 8, wherein based on determining that the first object data associated with the at least one first component of the plurality of components of the lawn mower does not match the at least one existing object data record of the plurality of existing object data records, the at least one processor is configured to:
generate an object data record comprising the first object data associated with the at least one first component of the plurality of components of the lawn mower;
update the plurality of existing object data records to include the object data record comprising the first object data associated with the at least one first component of the plurality of components of the lawn mower to provide an updated plurality of existing object data records; and
determine the second location underneath the second side of the lawn mower based on the updated plurality of existing object data records.

11. The orientation system of claim 1, wherein the at least one second component of the plurality of components of the lawn mower is a blade, wherein the task comprises sharpening the blade.

12. A method for orienting a robot relative to a lawn mower, the robot comprising a drive system configured to move the robot, at least one sensor, and at least one processor operatively connected to the drive system and the at least one sensor, the lawn mower comprising a plurality of components, the method comprising:
determining, by at least one processor, first object data associated with at least one first component of the plurality of components of the lawn mower based on a first signal received from the at least one sensor, wherein the first signal is detected by the at least one sensor at a first location, wherein the first location is a location adjacent to a first side of the lawn mower;
controlling, by at least one processor, the drive system to drive from the first location to a second location based on the first object data, wherein the second location is a location underneath a second side of the lawn mower;
determining, by at least one processor, second object data associated with at least one second component of the plurality of components of the lawn mower based on a second signal received from the at least one sensor, wherein the second signal is detected by the at least one sensor at the second location underneath the second side of the lawn mower; and
controlling, by at least one processor, the robot to perform a task based on the second object data associated with the at least one second component of the plurality of components of the lawn mower.

13. The method of claim 12, wherein the at least one sensor comprises one of a light detection and ranging (LiDAR) sensor, a time-of-flight (ToF) sensor, a proximity sensor, an optical sensor, an image sensor, and/or any combination thereof.

14. The method of claim 12, wherein the drive system comprises at least one of a motor, a wheel, a ball, a track, and/or any combination thereof.

15. The method of claim 12, wherein the robot further comprises at least one camera, the method further comprising:
controlling, by at least one processor, the at least one camera to capture the first object data associated with at least one first component of the plurality of components of the lawn, wherein the first object data is captured at the first location adjacent to the first side of the lawn mower.

16. The method of claim 12, further comprising:
determining, by at least one processor, the second location underneath the second side of the lawn mower based on the first object data.

17. The method of claim 12, further comprising:
querying, by at least one processor, a database comprising a plurality of existing object data records.

18. The method of claim 17, further comprising:
determining, by at least one processor, that the first object data associated with the at least one first component of the plurality of components of the lawn mower matches at least one existing object data record of the plurality of existing object data records; and
based on determining that the first object data associated with the at least one first component of the plurality of components of the lawn mower matches the at least one existing object data record of the plurality of existing object data records, determining, by at least one processor, the second location underneath the second side of the lawn mower.

19. The method of claim 17, further comprising:
determining, by at least one processor, that the first object data associated with the at least one first component of the plurality of components of the lawn mower does not match at least one existing object data record of the plurality of existing object data records; and
based on determining that the first object data associated with the at least one first component of the plurality of components of the lawn mower does not match the at least one existing object data record of the plurality of existing object data records, generating, by at least one processor, an object data record comprising the first object data associated with the at least one first component of the plurality of components of the lawn mower;
updating, by at least one processor, the plurality of existing object data records of the database to include the object data record comprising the first object data associated with the at least one first component of the plurality of components of the lawn mower to provide an updated plurality of existing object data records; and
determining, by at least one processor, the second location underneath the second side of the lawn mower based on the updated plurality of existing object data records.

20. The method of claim 12, wherein the at least one second component of the plurality of components of the lawn mower is a blade, wherein the task comprises sharpening the blade.
